(19) United States
(12) Patent Application Publication
(10) Pub. No.: US 2006/0036521 A1
(43) Pub. Date: Feb. 16, 2006

(54) Method and system for managing financing arrangements

(76) Inventors: Werner Laber, Ubstadt-Weiher (DE); Rolf Wickenhoefer, Heidelberg (DE); Alfred Schaller, Heidelberg (DE); Martin Walter Schroter, Bad Schoenborn (DE)

Correspondence Address: KENYON & KENYON, 1500 K STREET NW, SUITE 700, WASHINGTON, DC, 20005, US

(21) Appl. No.: 10/915,409

(22) Filed: Aug. 11, 2004

(51) Int. Cl. G06Q 40/00

(52) U.S. Cl. 705/35

(57) ABSTRACT

Embodiments of the present invention relate to a method and system for de-coupling a customer side from an investor side in software for supporting financing arrangements. According to the embodiments, a link object may be arranged between customer objects and investor objects, and handle operations that need to be performed because of a relationship between the customer objects and the investor objects. The link object therefore effectively de-couples the customer side from the investor side, since there need not be any direct association between the customer and the investor side. A more flexible solution for the needs of financial business is accordingly provided.

### BACKGROUND OF THE INVENTION

Banks offer financial products. Examples of financial products include loans and leases. Financial products offered by banks may be backed by investors. Consider, for example, loans. A given bank may not necessarily want or be able to independently finance the loans that it provides to its customers. Instead, the bank may form a financing arrangement with investors (often other banks) who provide all or part of the money needed for the loans. The investors realize their profit (it is expected) from periodic payments based on whatever contractual terms govern the financing arrangement. The lending bank, for its part, earns money from its share in the loans and by managing the loans.

A financing arrangement as described above may be viewed as involving a “customer side” and an “investor side,” with a bank in the middle. That is, customers apply for and receive loans from a bank, investors supply the needed money, and a bank interfaces with both the customers and the investors and acts as an intermediary. Typically, customers need never know about the financing arrangement that provides the money the bank loans them. Investors may have more knowledge about the arrangement, but leave it up to the bank to administer the details.

An example of a financing arrangement involving a customer side and an investor side is a “syndication.” In a syndication, one or more investors finances a customer-end bank product such as a loan or a lease. A lead bank coordinates administrative operations such as document processing and handling of payments (e.g., receiving payments from a borrower and delivering corresponding payments to investors in accordance with an agreed-upon distribution). A participation is a form of syndication where the lead bank is also an investor in the loan or lease.

Another example of a financing arrangement involving a customer side and an investor side is a “securitization.” In a securitization, loans (such as mortgages) or leases are arranged in pools, and an investor buys the pool of loan or leases. The customer (in this example) is the mortgagor.

Financing arrangements in general may further be characterized as “big ticket” (involving comparatively big amounts of capital, for example $20 million) or “small ticket” (involving comparatively small amounts of capital) on either the customer side or the investor side. Usually big tickets are loan or leases given to companies or governments, and the like. Small tickets are usually given to individuals. For example, a mortgage loan given to buy a house is a small ticket.

Software for helping banks manage/administer financing arrangements is known. However, the software typically offers only patchwork, specialized solutions; there is no generalized solution. For example, a given software package might be able to handle loans but not leases, or syndications but not securitizations, or big tickets but not small tickets, and so on. Moreover, known solutions are not very flexible or adaptable. This is in part because the software tends to be monolithic. For example, the customer side and the investor side are usually tightly coupled, with customer-side data associated directly with corresponding investor-side data. This means that it can be difficult to adapt the software to changing needs. Because the constantly changing and fast-paced world of finance demands flexibility and adaptability in its supporting software, an approach that addresses the limitations of the prior art is called for.

### BRIEF DESCRIPTION OF THE DRAWINGS

FIGS. 1-5 shows various relationships of objects according to the present invention;

FIG. 6 shows a system according to embodiments of the present invention;

FIG. 7 shows a process flow according to embodiments of the present invention; and

FIG. 8 shows a computer platform for implementing computer-executable functionality according to embodiments of the present invention.

### DETAILED DESCRIPTION

Embodiments of the present invention relate to a method and system for de-coupling a customer side from an investor side in software for supporting financing arrangements. According to the embodiments, a link object may be arranged between customer objects and investor objects, and handle operations that need to be performed because of a relationship between the customer objects and the investor objects. The link object therefore effectively de-couples the customer side from the investor side, since there need not be any direct association between the customer and the investor side.

Additionally, the embodiments may comprise a high-level financing object representing an investor agreement. The financing object may comprise criteria and rules based at least in part on the agreement for governing a behavior of a link object. By suitably configuring a financing object and an associated link object or objects, these objects may be adapted to support a variety of different financing arrangements for a variety of different financial products. By de-coupling the customer side from the investor side and by controlling operations from a financing object and associated link object(s), software structures according to embodiments of the present invention are made flexible and readily adaptable to changing needs.

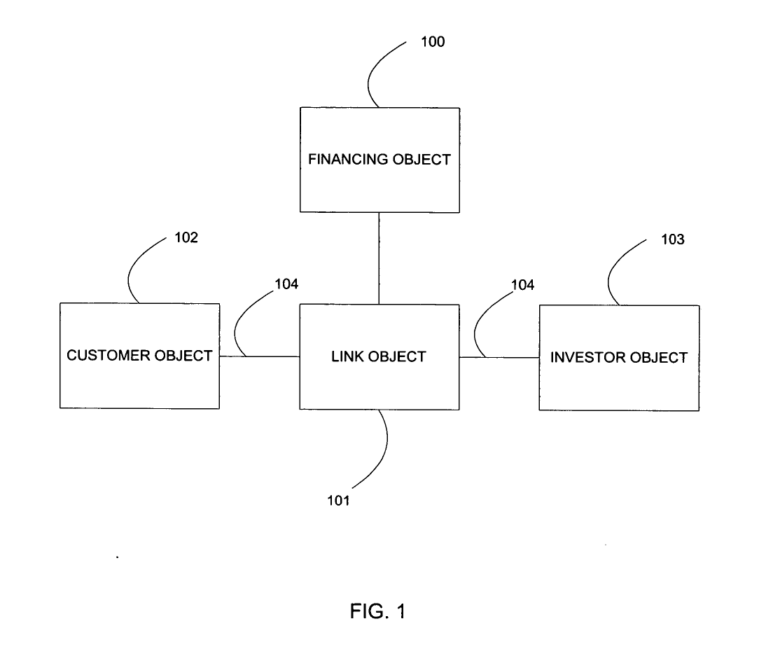

As shown in FIG. 1, embodiments of the present invention may comprise a financing object 100 related to a link object 101. The link object 101 in turn is related or linked via links 104 to a customer object 102 and an investor object 103. The objects correspond to data that may be stored electronically on a machine-readable medium, and to functionality executable on a computer. For example, each object may represent a quantum of data or a grouping of related data on a database, and provide functionality via object interfaces to retrieve and perform operations on the data. Similarly, the links 104 may correspond to electronically stored information representing a relationship between linked objects.

The financing object 100 may represent a high-level agreement with an investor, represented by the investor object 103. The agreement may set forth what kind of financing arrangement (e.g., syndication or participation) for investment by the investor in a financial product will be used. The agreement may further set forth criteria under which the investor will agree to invest in a particular financial product, such as a loan or a lease, represented by the customer object 102. The terms of the agreement may be reflected in the financing object 100 by configuration thereof. If a given financial product meets the criteria of the agreement, a relationship between the customer object 102 and the investor object 103 may be created because of the fact the investor has agreed to buy the financial product. To manage this relationship, a link object 101 may be created, and each of the customer object 102 and the investor object 103 linked to the link object.

The link object 101 may comprise functionality to handle operations that need to be performed because of the relationship between the customer side and the investor side, but there may be no direct communication between the customer and the investor side. For example, the link object 101 may handle all payments by the customer side, applying them to an account of the investor. The link object 101 may further monitor events on the customer side which may change the status of the customer object with respect to the investor agreement (e.g., a borrower moves out of the country) and perform a corresponding action (e.g., buy back the borrower's loan). Because the link object manages such matters, the customer side and the investor side are effectively de-coupled.

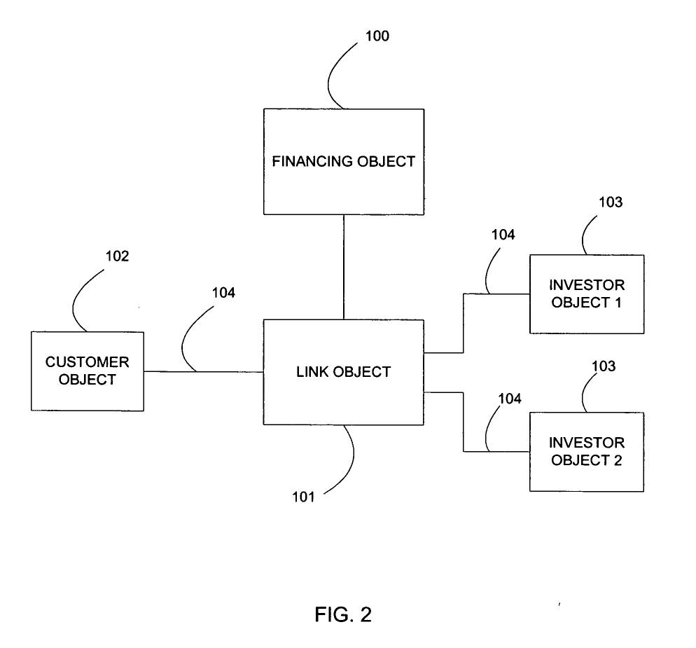

FIG. 2 shows an example of another arrangement according to embodiments of the present invention wherein there is a single customer object 102 but a plurality of investor objects linked to a link object 101. The arrangement shown in FIG. 2 may, for example, correspond to a big-ticket loan, i.e., a loan for a large amount financed by a plurality of investors. Of course, the number of investors and corresponding investor objects is not limited to two.

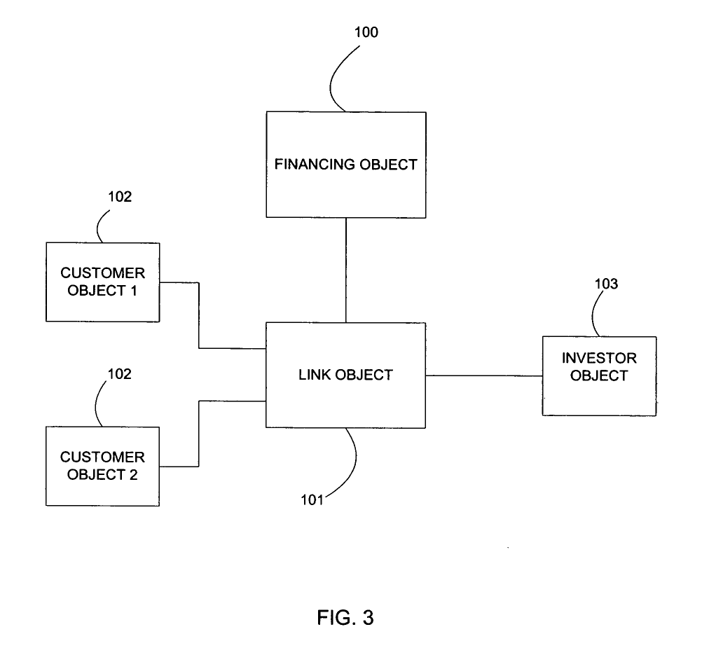

FIG. 3 shows an example of still another possible arrangement according to embodiments of the present invention. FIG. 3 shows a link object 101 related to a plurality of customer objects 102, but to a single investor object 103. The arrangement shown in FIG. 3 may, for example, correspond to a pool of small loans financed by a single large investment. The number of loans and corresponding customer objects is not limited to two.

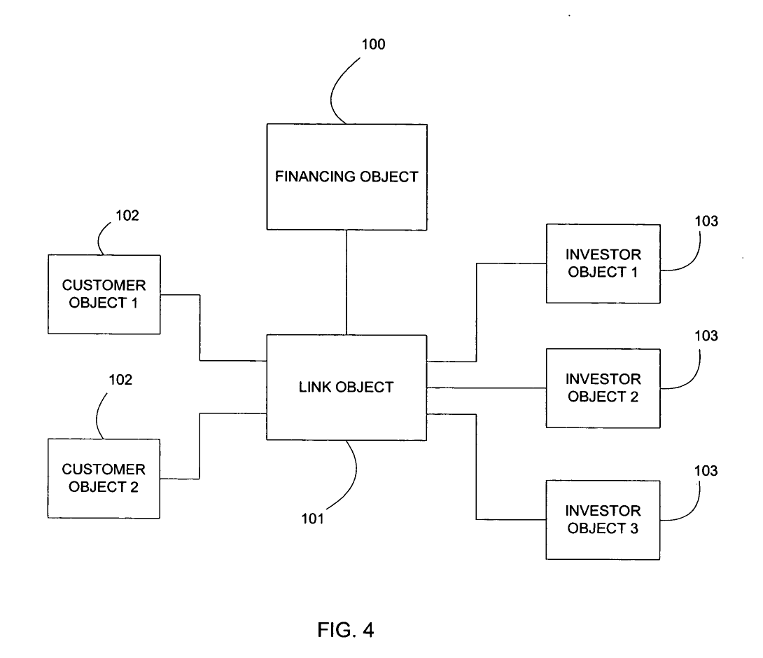

FIG. 4 shows an example of yet another possible arrangement according to embodiments of the present invention. In FIG. 4, the link object 101 is related to a plurality of customer objects 102 and to a plurality of investor objects 103.

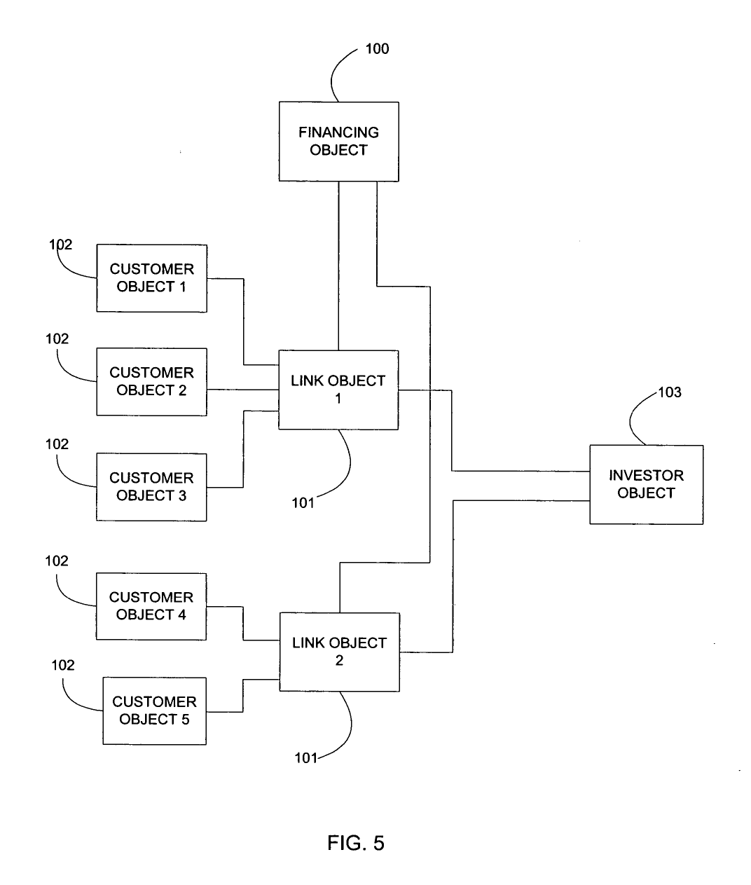

FIG. 5 shows another example of an arrangement according to embodiments of the present invention. In FIG. 5, a plurality of link objects 101 is related to a financing object 100. Each link object 101 is further linked to a plurality of customer objects 102 and to a single investor object 103. The arrangement of FIG. 5 may correspond, e.g., to a pool as mentioned earlier, where a maximum size limit may have been reached for a first link object, link object 1, and therefore a new link object, link object 2, was created to handle new loans. This is discussed in more detail in the following.

As noted earlier, a link object 101 may handle operations needed that arise out of a relationship between a linked customer object 102 and a linked investor object 103. A link object 101 may be defined by parameters set forth pursuant to the creation of a governing or controlling financing object 100. More specifically, upon the establishment of an agreement with an investor, a user (such as a managing or participating bank) may create a financing object 100 reflecting the agreement. The financing object 100 may correspond to the type of financing arrangement that is being established (e.g., a syndication, a securitization, a participation) under the agreement. A user may enter values through a user interface, for example, to configure a financing object. A link object governed by the financing object may also be defined through the user interface.

The financing object 100 may include criteria that a financial product must meet in order to qualify for sale to an investor. For example, if the financial product that is being offered to the investor under the agreement is loans, the loans may need to be of a certain quality before the investor will agree to buy them. If a loan or loans meet the criteria, they may be sold to the investor, consequently creating a relationship between the loan (represented by a customer object) and the investor (represented by an investor object). A link object may accordingly be created to reflect this relationship, and parameters based on the financing object may be defined for the link object. The parameters for a link object may include its type (i.e., what kind of financing arrangement it is set up for or represents), its minimum size (i.e., a minimum amount of money that it must represent), its maximum size (i.e., a maximum amount of money that it may represent), a number of objects that can be linked to the link object, and the like. The financing object provides a top-level entry point in the software for all link objects related to it. For example, by accessing a financing object, a list of all link objects related to financing object may be obtained.

When a link object is created, customer or investor objects may be linked to it. The customer or investor objects could be pre-existing, or could be linked on an ongoing basis as they came into being. The customer objects could be linked based on the criteria of the financing object. For example, the user interface for creating a financing object and parameterizing a link object might include a function allowing for the definition of selection criteria based on the underlying investor agreement. The selection criteria could be applied to a database of customer objects, and a list could be returned of those customer objects meeting the criteria. A user might then manually establish links for those customer objects to a link object. However, the process need not be manual; links could be formed automatically on an ongoing basis. For example, a bank might do regular business with a large investor, wherein periodically, as new loans were made meeting the criteria of the investor agreement, the bank might execute a “batch” computer program to link the new loans to a link object under the financing object representing the investor agreement.

Multiple link objects for a financing object, as shown in the example of FIG. 5, may result from the parameterization of link objects as described above. For example, when size limits of a given link object were reached, a new link object could be created for new customer or investor objects. Again, this might happen automatically on an ongoing basis, for example in a situation where a bank does regular business with a large investor. If, due to size limits, existing link objects could not accommodate newly originated loans qualifying under the investor's criteria, a new link object or objects might be created for the newly originated loans. The new loans (represented by customer objects) would then be linked to the new link object(s), and the new link object(s) would be related to the governing financing object.

New link objects could be created based on other, arbitrary conditions that don't necessarily involve size restrictions. For example, an investor agreement might state, “create a pool monthly, ” or “create a pool quarterly.” New link objects reflecting the creation of such pools might accordingly be automatically created at these times.

A link object may process events concerning customer and investor objects to which it is linked. Such events could include transactions or changes in master data. An example of a transaction is the creation of a new record in a customer transaction database, such as a loan payment. An example of a change in master data is a change in a customer address. A link object may comprise functionality to determine whether an event has occurred, and to determine how to process the event. To determine how to process an event, a link object may refer to rules that are at least in part based on the agreement represented by the financing object.

To determine whether an event has occurred, a link object may read a transaction database to determine whether any new records have been created. If there is a new record or records in the database, the link object may process it/them. In the example of a payment on a loan, the link object might calculate an amount of the payment to be transferred an investor account, and perform the transfer. A change in master data, on the other hand, might involve the changing of fields in a master database. For example, the change might be a change in a customer address. If there has been a change in master data, the link object may determine what action to take in response, by consulting the rules.

It could be the case under the rules that no action was needed. For example, a rule might state that if a borrower changes residence but stays within the country, no action is needed. The rule might further state, on the other hand, that if a borrower leaves the country, he may no longer qualify to be part of a pool, based on an investor agreement. In such a situation, a managing bank might be required under the agreement to buy back the loan. Accordingly, the link object associated with the loan might calculate the current price of the loan, apply the calculated amount to the investor's account, and dissolve the loan's link to the link object. It should be appreciated in view of the wide variety of circumstances that the rules would need to cover that the rules are not fixed, but could be updated over the course of time.

The processing of events by link objects according to embodiments of the present invention could occur periodically, for example as part of the execution of a batch program or programs for maintaining a financing arrangement. Banks may execute such batch programs daily, weekly or monthly, for example. Or, the events could be processed by the link object in a more random fashion, for example at the request of another software component interested in the event information.

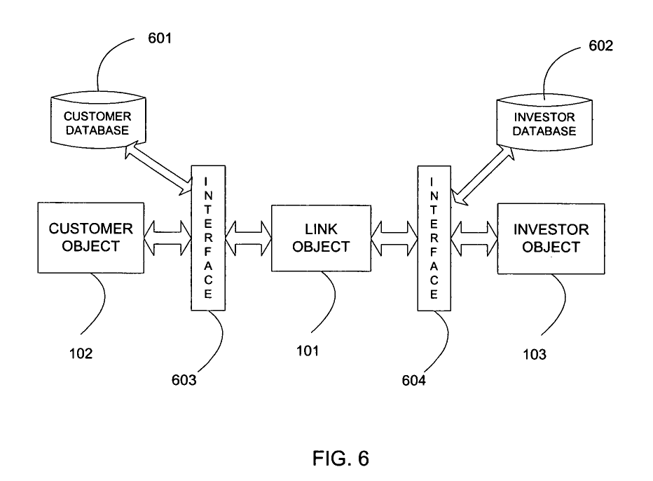

FIG. 6 shows an example of a system according to embodiments of the present invention. The system may comprise a customer database 601 and an investor database 602. The customer database 601 may include customer transactional data (e.g., payment records as discussed above) and customer master data. The customer master data could include such information as a customer object type (e.g., loan or lease), a customer object status, customer information (e.g., name, address, etc.), conditions such as interest, fees, principal payment amount, and cash flow (historic and planned). Similarly, the investor database 602 may include such information as an investor object type, an investor object status, investor information (e.g., name, address, etc.), conditions such as interest, fees, principal payment amount, and cash flow (historic and planned).

To manage a link between a customer object 102 and a link object 101, a link object 101 may consult the customer database 601 to determine whether there are any transactions or master data changes relating to the link to be processed. To access the data on the database 601, the link object 101 may use an interface 603 comprising functionality (e.g., “methods”) provided by the customer object 102 for accessing data that relates to it. The link object 101 may process any customer transactions and/or changes to customer master data in accordance with rules based at least in part on an agreement represented by a governing financing object to which the link object is related. The link object may then apply the results of any processing to the investor database 602 using, for example, an interface 604 of the investor object 103.

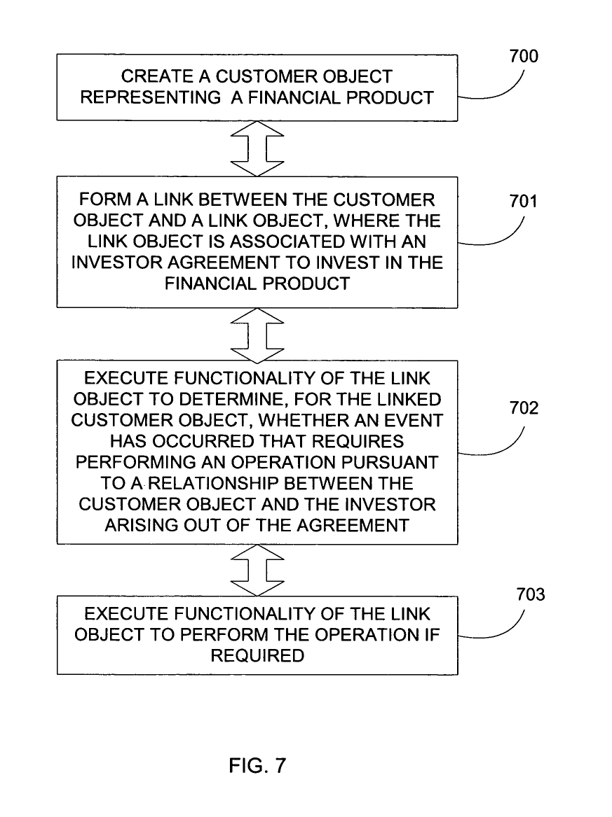

In light of the foregoing discussion, FIG. 7 shows a process flow according to embodiments of the present invention. As shown in block 700, the process may include creating a customer object representing a financial product, such as a loan or a lease. If the financial product meets the criteria of an investor agreement, which may be represented by a financing object, the process, as shown in block 701, may further comprise forming a link between the customer object and a link object, where the link object is associated with the agreement, under the financing object.

As shown block 702, the process may further comprise executing functionality of the link object to make a determination, for the linked customer object, whether an event has occurred that requires performing an operation pursuant to a relationship between the customer object and the investor arising out of the agreement. As described above, making such a determination could involve determining whether new customer records have been created, or whether there have been changes to customer master data.

As shown in block 703, the process may further comprise executing functionality of the link object to perform the operation if required. The operation could include, for example, applying a customer payment, buying back a loan, or the like, as described earlier.

Components of the present invention could execute on a plurality of hardware platforms in a client-server environment. The environment may include client machines to handle front-end processing (e.g., user interfaces), application servers to process application logic, and database servers to handle the database access.

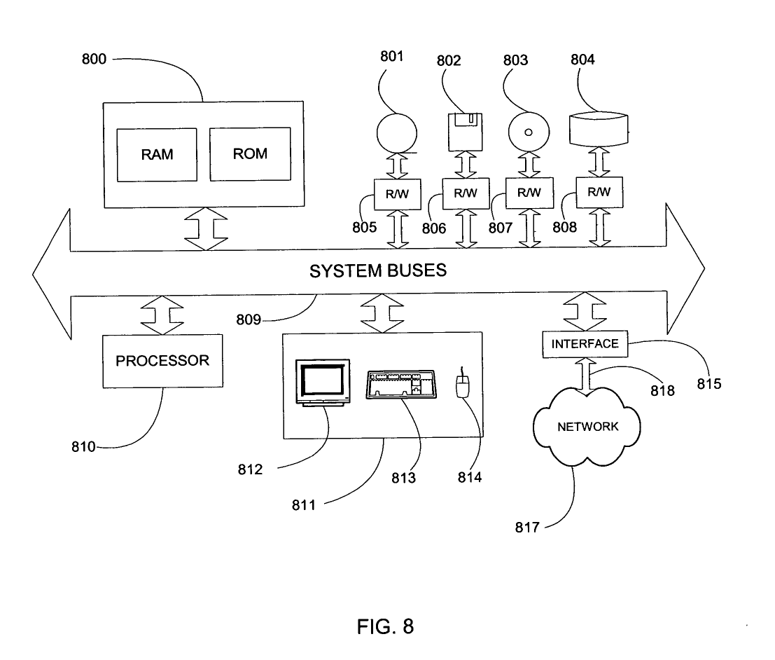

FIG. 8 shows a high-level representation of a computer hardware platform for implementing (e.g., coding and executing) embodiments of the present invention, such as might be realized by a variety of known and commercially available hardware and software elements. The system may comprise a memory 800 including ROM and RAM, processor 810 and user interface 811 comprising a display device 812, keyboard 813 and mouse 814. Elements may communicate via system buses 809. The system may further comprise a network 817 connected by a network medium 818 and network interface 815.

A computer program or collection of programs comprising computer-executable instructions according to embodiments of the present invention may be stored and transported on machine-readable media such as diskette 801, CD-ROM 802, magnetic tape 803 and fixed disk 804. The computer instructions may be retrieved from the machine-readable media 801-804 using their respective reading devices 805-808 into memory 800, and executed by a processor 810. The functionality disclosed hereinabove for performing the embodiments may find specific implementations in a variety of forms, which are considered to be within the abilities of a programmer of ordinary skill in the art after having reviewed the specification.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method comprising:
creating a customer object representing a financial product;
forming a link between the customer object and a link object, wherein the link object is associated with an agreement with an investor to invest in the financial product;
executing functionality of the link object to make a determination, for the linked customer object, whether an event has occurred that requires performing an operation pursuant to a relationship between the customer object and the investor arising out of the agreement; and
executing functionality of the link object to perform the operation if required.

2. The method of claim 1, wherein the functionality of the link object makes the determination based at least in part on rules based at least in part on the agreement.

3. The method of claim 1, wherein the event is the creation of a new record associated with the customer object.

4. The method of claim 1, wherein the event is a change in data associated with the customer object.

5. The method of claim 1, wherein the financial product is a loan.

6. The method of claim 1, wherein the financial product is a lease.

7. A method comprising:
creating a financing object corresponding to an investor agreement to invest in a financial product;
defining parameters of a link object associated with the financing object, wherein the parameters include at least one of a minimum or maximum money amount to be represented by the link object;
creating customer objects corresponding to newly originated financial products; and
linking the customer objects to the link object in accordance with the parameters.

8. The method of claim 7, further comprising:
if an amount of money represented by the customer objects exceeds the maximum money amount, creating a new link object and linking one or more of the customer objects to the new link object.

9. The method of claim 7, further comprising:
executing functionality of the link object to process events associated with the linked customer objects.

10. A system comprising:
a financing object corresponding to an investor agreement to invest in a financial product;
a link object associated with the financing object to perform operations pursuant to a relationship between a customer object and an investor object corresponding to the investor agreement;
a customer object linked to the link object, the customer object representing the financial product; and
an investor object linked to the link object, the investor object representing an investor that is a party to the agreement.

11. The system of claim 10, wherein the link object is linked to only one customer object but to a plurality of investor objects.

12. The system of claim 10, wherein the link object is linked to only one investor object but to a plurality of customer objects.

13. The system of claim 10, wherein the link object is linked to a plurality of customer objects and to a plurality of investor objects.

14. The system of claim 10, wherein the financing object is associated with a plurality of link objects.

15. The system of claim 10, wherein the financing object includes criteria for forming a link between a customer object and the link object.
